(19) United States
(12) Patent Application Publication
(10) Pub. No.: US 2007/0030581 A1
(43) Pub. Date: Feb. 8, 2007

(54) Rear vision system with automatic blind zone and glare elimination function

(76) Inventor: Jenne-Tai Wang, Rochester, MN (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/198,213

(22) Filed: Aug. 5, 2005

(51) Int. Cl. G02B 5/08; G02B 7/18; G02B 7/182

(52) U.S. Cl. 359/843; 359/872

(57) ABSTRACT

A system (60) for automatically changing the position of the side mirrors (14, 16) of a vehicle (10) between a blind zone side mirror setting position and a blind zone/glare elimination (BGE) side mirror setting position in response to actuation of a switch (68). From the angle of the driver side mirror (14) an equation can be used to determine the distance between the driver side mirror (14) and the vehicle operator's eyes. Based on the angle of the driver side mirror (14), the system (60) will know whether the driver set the driver side mirror (14) for the blind zone setting method or the BGE setting method. If the vehicle operator actuates the switch (68), then the system (60) will use the distance from the vehicle operator's eyes to the driver side mirror (14) to set the angle for the other of the blind zone setting method or the BGE setting method based on predetermined equations.

### BACKGROUND OF THE INVENTION

1. Field of the Invention

This invention relates generally to a system for setting the angle of the side mirrors of a vehicle and, more particularly, to a system for automatically switching the side mirrors of a vehicle between a blind zone side mirror setting position and a blind zone/glare elimination side mirror setting position in response to a vehicle operator input.

2. Discussion of the Related Art

It is known in the art to automatically adjust the position of the passenger side mirror and the interior rear view mirror of a vehicle in response to angle adjustments made by the vehicle operator to the driver side mirror. The system determines the position of the vehicle operator's eyes based on the angle of the driver side mirror, and then adjusts the position of the passenger side mirror or the interior rear view mirror based on the eye position.

Typically, a vehicle operator will set the angle of the vehicle side mirrors at a location where blind zones are defined on both sides of the vehicle. This is referred to in the art as a blind zone side mirror setting method. It is also known in the art to set the position of the vehicle side mirrors to eliminate the blind zones and rear view mirror glare, referred to in the art as a blind zone/glare elimination (BGE) side mirror setting method. In the BGE method, the vehicle operator moves his head to the far left to set the driver side mirror and the far right to set the passenger side mirror. This allows the side mirrors to be used to see the vehicle blind zones at the sides of the vehicle when the driver is in the normal driving position, and use the interior rear view mirror to see the remainder of the area behind the vehicle.

Circumstances may exist where the vehicle operator wishes to change the position of the side mirrors between the blind zone setting position and the BGE setting position for different vehicle operating situations. For example, the vehicle operator may wish to use the BGE setting method to eliminate the blind zones. However, if the vehicle is carrying something that blocks the interior rear view mirror, then the vehicle operator may wish to switch the side mirrors to the blind zone setting position. Further, the vehicle operator may choose to switch the side mirrors from the blind zone position method to the BGE setting position while operating the vehicle. However, because the vehicle operator is required to move his head to do this while driving, driver distraction issues could be a concern. It would be desirable to allow the vehicle operator to automatically switch the side mirror positions from the blind zone setting method to the BGE setting method, and vice versa, in response to activation of a switch.

### SUMMARY OF THE INVENTION

In accordance with the teachings of the present invention, a system is disclosed for automatically changing the position of the side mirrors of a vehicle between a blind zone side mirror setting position and a BGE side mirror setting position in response to actuation of a switch. A vehicle operator will adjust the angle of the driver side mirror. From the angle of the driver side mirror an equation can be used to determine the distance between the driver side mirror and the vehicle operator's eyes. In one embodiment, this position is also used to automatically set the angle of the interior rear view mirror and the passenger side mirror. Based on the angle of the driver side mirror, the system will know whether the driver set the driver side mirror for the blind zone setting method or the BGE setting method. If the vehicle operator actuates the switch, then the system will use the distance from the vehicle operator's eyes to the driver side mirror to set the angle for the other of the blind zone setting method or the BGE setting method based on predetermined equations.

Additional features of the present invention will become apparent from the following description and appended claims taken in conjunction with the accompanying drawings.

### BRIEF DESCRIPTION OF THE DRAWINGS

FIG. 1 is a plan view of a vehicle showing a process for determining the position of a vehicle operator's eyes for a blind zone side mirror setting method;

FIG. 2 is a plan view of a vehicle showing a process for determining the position of a vehicle operator's eyes for a blind zone/glare elimination side mirror setting method;

FIG. 3 is a flow chart diagram showing a process for switching the side mirror setting position between a blind zone side mirror setting method and a blind zone/glare elimination side mirror setting method, according to an embodiment of the present invention;

FIG. 4 is a block diagram of an automatic blind zone and glare elimination rear view system, according to an embodiment of the present invention; and

FIG. 5 is a flow chart diagram showing a process for controlling the automatic blind zone and glare elimination rear view mirror system shown in FIG. 4.

### DETAILED DESCRIPTION OF THE EMBODIMENTS

The following discussion of the embodiments of the invention directed to a process for automatically switching between a blind zone side mirror setting position and a blind zone/glare elimination side mirror setting position is merely exemplary in nature, and is in no way intended to limit the invention or its applications or uses.

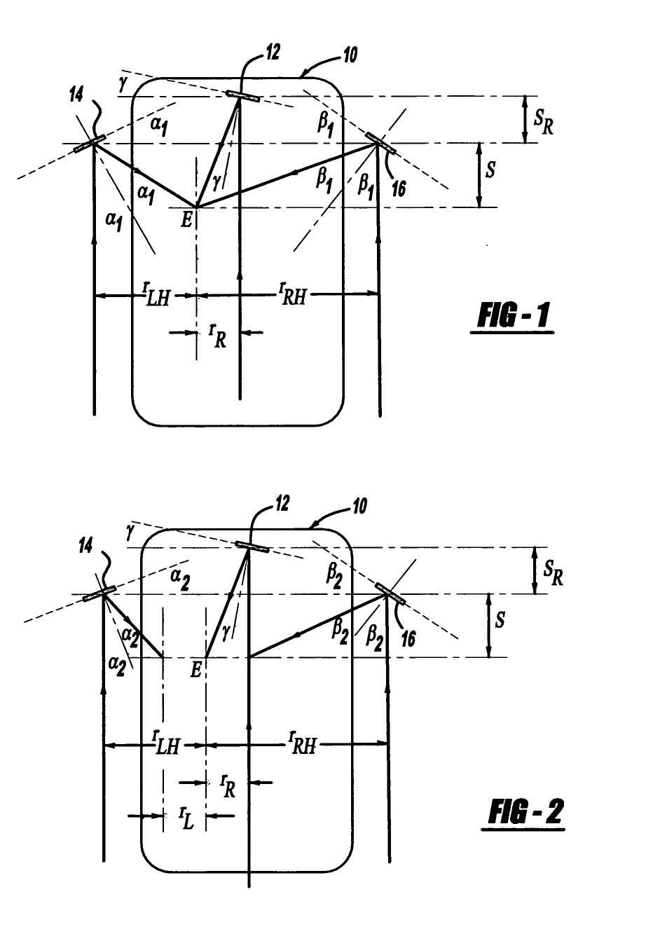

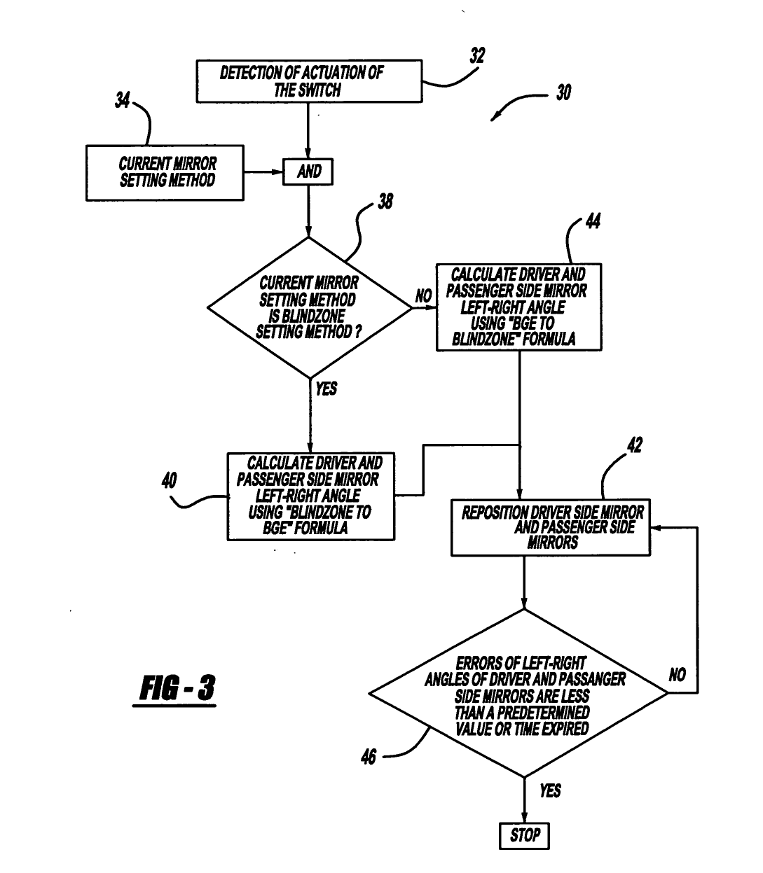

FIGS. 1 and 2 are a plan view of a vehicle 10 including an interior rear view mirror 12, a driver side mirror 14 and a passenger side mirror 16. Point E represents the position of the driver's eyes during normal driving and S is the distance from the driver's eyes to the driver's side mirror 14 in a forward direction. The variable r_{LH} is the lateral distance between point E and the driver side mirror 14, the variable r_{RH} is the lateral distance between the driver's eyes and the passenger side mirror 16, the variable r_{R} is the lateral distance between the driver's eyes and the rear view mirror 12, the variable r_{R} is the lateral distance between the driver's eyes during normal vehicle operation and the position of the driver eyes for setting the passenger side mirror 16 for the BGE setting method, the variable r_{L} is the lateral distance between the driver's eyes during normal vehicle operation and the position of the driver's eyes for setting the driver side mirror 14 during the BGE setting method, S_{R} is the distance between the driver side mirror 14 and the rear view mirror 12 in the forward direction, γ is the angle of the rear view mirror 12, α₁, and α₂ are the angle of the driver side mirror 14 and β₁ and β₂ are the angle of the passenger side mirror 16 for the blind zone setting method and the BGE setting method, respectively. The variables r_{LH}, r_{RH}, r_{R}, r_{L}, and S_{R} are all known from the specific vehicle parameters.

From FIG. 1, the following equations are defined for the blind zone side mirror setting method.

$$\begin{matrix}S = \frac{{r}_{LH}}{tan 2 {α}_{1}} & ( 1 ) \\ {β}_{1} = \frac{1}{2} {tan}^{- 1} ( \frac{{r}_{RH}}{S} ) & ( 2 ) \\ γ = \frac{1}{2} {tan}^{- 1} ( \frac{{r}_{R}}{S + {S}_{R}} ) & ( 3 )\end{matrix}$$

From FIG. 2, the following equations are defined for the BGE side mirror setting method:

$$\begin{matrix}S = \frac{{r}_{LH} - {r}_{L}}{tan 2 {α}_{2}} & ( 4 ) \\ {β}_{2} = \frac{1}{2} {tan}^{- 1} ( \frac{{r}_{RH} - {r}_{R}}{S} ) & ( 5 ) \\ γ = \frac{1}{2} {tan}^{- 1} ( \frac{{r}_{R}}{S + {S}_{R}} ) & ( 6 )\end{matrix}$$

According to the invention, once the vehicle operator has set the position of the driver side mirror for either the blind zone side mirror setting method or the BGE side mirror setting method, then the system can automatically reposition the side mirrors 14 and 16 to the other of the blind zone side mirror setting position or the BGE side mirror setting position in response to an input signal from the vehicle operator. Particularly, once the vehicle operator sets the angle of the driver side mirror 14, then the angle α₁ or α₂ of the driver side mirror 14 is known, depending on which side mirror setting method is used. The angle α₁, or α₂ can then be used to calculate the distance S to determine the position of the vehicle operator's eyes E using equation (1) or (4). Once the distance S is known, then the system can automatically switch the angle of the side mirrors between the blind zone side mirror position and the BGE side mirror position using the above equations. The system will know which side mirror setting method the vehicle operator used because of the driver side mirror angle. Particularly, the possible angles of the driver side mirror 14 for the blind zone side mirror setting method would not overlap with the possible angles of the driver side mirror 14 for the BGE side mirror setting method.

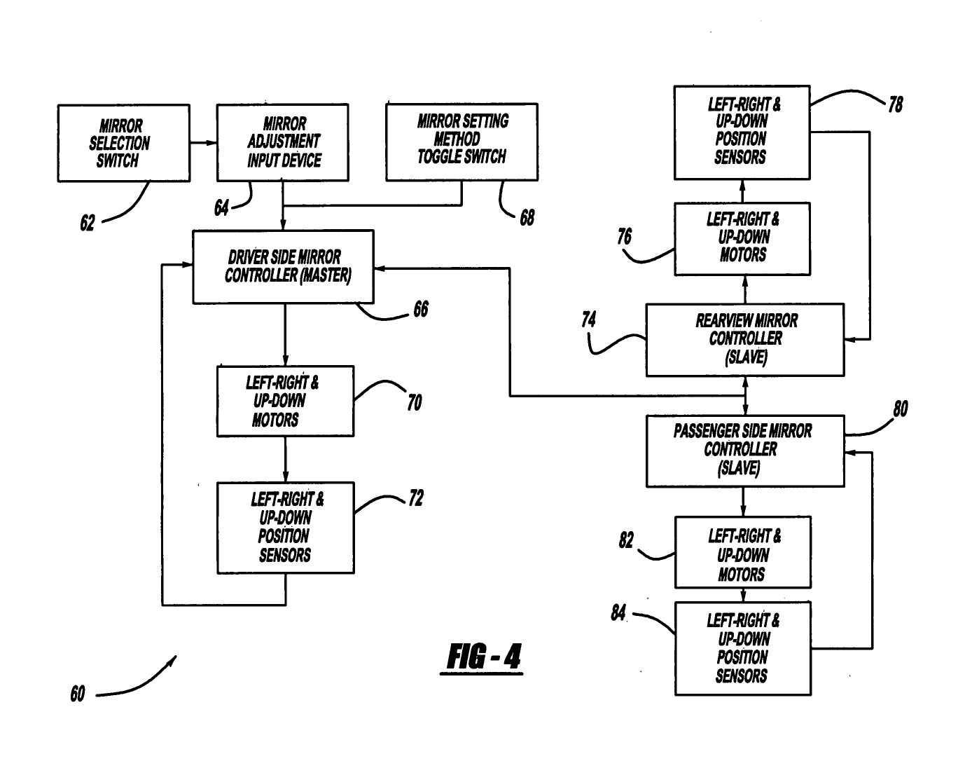

FIG. 3 is a flow chart diagram 30 showing an algorithm for resetting the position of the vehicle side mirrors 14 and 16 from the blind zone setting position to the BGE setting position, or vice versa, according to an embodiment of the invention. The algorithm detects the actuation of a switch at box 32 and detects the current driver side mirror and/or passenger side mirror position at box 34. Actuating the switch lets the algorithm know that the vehicle operator wants to change the position of the side mirrors 14 and 16 from their current setting position to the other position using the other setting method. The algorithm will know the current setting method of the side mirrors 14 and 16 based on the angle of the side mirror 14. Particularly, if the driver has set the side mirrors 14 and 16 for the blind zone setting method, then the angle of the side mirror 14 will be within one particular range of angles, and if the driver has set the angle of the side mirrors 14 and 16 for the BGE setting method, then the angle of the side mirror 14 will be within a completely different range of angles.

The algorithm then determines whether the current side mirror position is the blind zone setting position at decision diamond 38. If the current side mirror position is the blind zone setting position, then the algorithm calculates the new angle of the side mirrors 14 and 16 using the conversion from the blind zone setting method to the BGE setting method at box 40, as discussed above. The algorithm then sets the position of the side mirrors 14 and 16 at box 42. If the current side mirror position is not the blind zone setting position at the decision diamond 38, then the algorithm calculates the new angle of the side mirrors 14 and 16 using the conversion from the BGE setting method to the blind zone setting method at box 44, as discussed above. The algorithm then repositions the side mirrors 14 and 16 at the box 42. The algorithm then determines whether the side mirrors 14 and 16 are at the appropriate position based on the discussion above at decision diamond 46, and if not, returns to the box 42 to set the position of the side mirrors 14 and 16. Particularly, it would take some time for the motors and actuators to move the side mirrors 14 and 16 from one position to the other position. The algorithm will monitor this movement until the side mirrors reach the desired position.

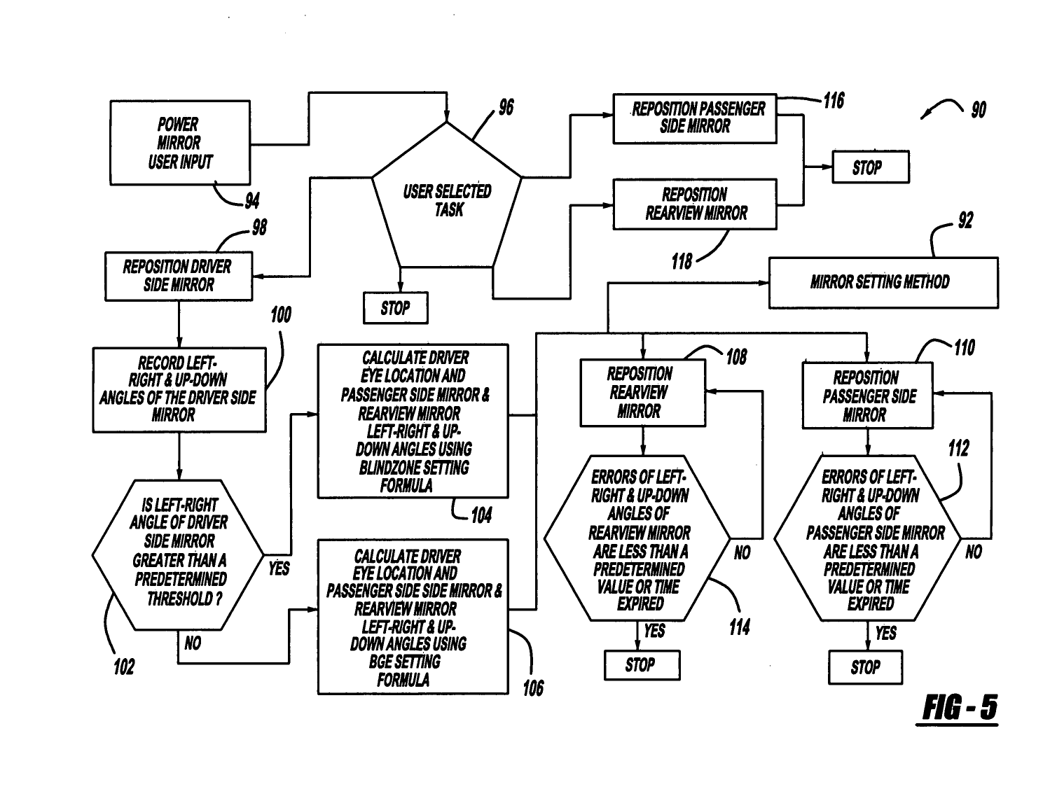

FIG. 4 is a block diagram of an automatic blind zone and BGE side mirror positioning system 60. When the vehicle operator adjusts the driver side mirror 14, the system 60 will automatically adjust the interior rear view mirror 12 and the passenger side view mirror 16. The system 60 includes a mirror selecting switch 62 for adjusting the position of the driver side mirror 14. A mirror adjustment input device 64 receives the mirror selection switch signal, and provides a signal to a driver side mirror or rear vision system master controller 66. A toggle switch 68 is also provided that automatically converts the blind zone side mirror setting position to the BGE side mirror setting position, or vice versa, as discussed above. The system master controller 66 operates left-right and up-down motors 70 to control the position of the driver side mirror 14 as the vehicle operator adjusts the mirror selection switch 62. Left-right and up-down position sensors 72 provide signals to the system master controller 66 so that the controller 66 knows the position of the driver side mirror 14.

When the position of the driver side mirror 14 is being set, then the angle of the driver side mirror 14 can be used to automatically set the angle of the interior rear view mirror 12 and the passenger side mirror 16. Particularly, a rear view mirror controller 74 receives mirror position signals from the system master controller 66 and adjusts the position of the interior mirror 12 using the equations above and left-right and up-down motors 76. The position of the interior rear view mirror 12 is determined by sensors 78 that provide the position of the interior rear view mirror 12 to the rear view mirror controller 74. Likewise, signals from the master controller 66 are sent to a passenger side mirror controller 80 that controls the position of the passenger side mirror 16 using the equations above and left-right and up-down motors 82. Left-right and up-down position sensors 84 detect the position of the side mirror 16 that are applied to the mirror controller 80.

The automatic switching between the blind zone side mirror setting position and the BGE side mirror setting position of the invention provides a number of advantages. These advantages include the ability to eliminate blind zone detection systems currently on some vehicles that use sensors, such as radars, lidars, etc., to provide an indication, such as a light signal, of when a vehicle is in the vehicle's blind zone. Thus, a reduction of costs can be achieved. Additionally, some vehicles are equipped with electro-chromic mirrors that detect light and reduce glare. However, such mirrors are typically expensive. By setting the angle of the side mirrors using the BGE side mirror setting method, side mirror glare would not occur because once a vehicle is in the other vehicle's blind zone, the headlights are too far forward to provide glare.

Further, some vehicles are equipped with a rear-view dimmer switch that allows the vehicle operator to switch the interior rear view mirror to a dimmer position. According to the invention, this same switch can be used to automatically switch the side mirrors from the blind zone setting position to the BGE setting position. Further, some vehicles are equipped with an electro-chromic rear view mirror, which includes an optical sensor in the rear view mirror that causes the rear view mirror to be automatically switched to the dimmer position. This signal can also be used to automatically switch the side mirrors 14 and 16 from the blind zone setting position to the BGE setting position. Because this may be considered an intrusive action, a provision might be provided to allow a driver to select or cancel this operation. Additionally, currently available driver head detection systems can be used to automatically set the side mirrors using either the blind zone setting method or the BGE setting method.

FIG. 5 is a flow chart diagram 90 showing an exemplary process for using the blind zone side mirror setting method and the BGE side mirror setting method of the invention discussed above in combination with other rear view mirror setting systems. Box 92 represents switching from the blind zone setting position to the BGE setting position or the BGE setting position to the blind zone setting position discussed above with reference to FIG. 3. The vehicle operator will select the power mirror position input at box 94. If the user selects the driver side rear mirror 14 through a selection box 96, then the algorithm repositions the driver side mirror 14 at box 98 and records the position of the driver side mirror 14 at box 100.

The algorithm then determines if the position of the driver side mirror 14 is greater than a predetermined threshold at decision diamond 102. If the position is greater than the predetermined threshold, meaning that the vehicle operator set the driver side mirror 14 for the blind zone setting method, then the algorithm calculates the driver's eye location, the passenger side rear view mirror 16 and the rear view mirror 12 angles using the blind zone side mirror equations (1)-(3) at box 104. If the position of the driver side mirror 14 is less than the predetermined threshold, meaning that the vehicle operator set the driver side mirror 14 for the BGE setting method, the algorithm calculates the location of the driver's eyes, the position of the passenger side mirror 16 and the rear view mirror 12 using the BGE equations (4)-(6) at box 106.

The algorithm then positions the rear view mirror 12 at box 108 and the passenger side mirror 16 at box 110. The algorithm also monitors the position of the rear view mirror 12 until it has reached its desired position and determines whether a predetermined time period has elapsed at decision diamond 112. Likewise, the algorithm monitors the position of the passenger side mirror 16 and determines whether it is at the desired position or a predetermined time period has expired at decision diamond 114. If the user has selected to position the passenger side mirror at the box 96, then the algorithm allows the vehicle operator to manually position the passenger side mirror at box 116. Similarly, if the user has selected to position the rear view mirror 12 at the selection box 96, then the algorithm allows the vehicle operator to manually position the rear view mirror 12 at box 118.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for positioning a driver side mirror and a passenger side mirror of a vehicle, said method comprising:
determining a current angle of the driver side mirror;
determining whether the driver side mirror is in a blind zone mirror position or a blind zone/glare elimination mirror position based on the angle;
detecting a command for switching to the other of the blind zone mirror position or the blind zone/glare elimination mirror position; and
moving both the driver side mirror and the passenger side mirror to the other of the blind zone mirror position or the blind zone/glare elimination mirror position in response to the command.

2. The method according to claim 1 wherein determining the current angle of the driver side mirror includes using position sensors.

3. The method according to claim 1 further comprising determining the position of a vehicle operator's eyes based on a setting angle of the driver side mirror and predetermined vehicle parameters.

4. The method according to claim 1 wherein moving the passenger side mirror includes automatically setting the angle of the passenger side mirror based on a setting angle of the driver side mirror.

5. The method according to claim 1 further comprising automatically setting the angle of an interior rear view mirror of the vehicle in response to a setting angle of the driver side mirror.

6. The method according to claim 1 wherein detecting a command for switching includes receiving an input from a switch.

7. The method according to claim 6 wherein the switch is a stand-alone switch.

8. The method according to claim 6 wherein the switch is a dimmer switch associated with an interior rear view mirror of the vehicle.

9. The method according to claim 1 wherein detecting a command for switching includes detecting a signal from an optical sensor associated with an auto dimmer of an interior rear view mirror of the vehicle.

10. A method for positioning a driver side mirror and a passenger side mirror of a vehicle, said method comprising
determining a current angle of the driver side mirror;
determining the position of a vehicle operators eyes based on the angle of the driver side mirror;
determining whether the driver side mirror is in a blind zone mirror position or a blind zone/glare elimination mirror position based on the angle;
detecting a command for switching to the other of the blind zone mirror position or the blind zone/glare elimination mirror position; and
moving the driver side mirror to the other of the blind zone mirror position or the blind zone/glare elimination mirror position based on the position of the operators eyes in response to the command.

11. The method according to claim 10 further comprising automatically setting the angle of the passenger side mirror based on the angle of the driver side mirror.

12. The method according to claim 10 further comprising automatically setting the angle of an interior rear view mirror of the vehicle in response to the angle of the driver side mirror.

13. The method according to claim 10 wherein detecting a command for switching includes receiving an input from a switch.

14. The method according to claim 13 wherein the switch is a stand-alone switch.

15. The method according to claim 13 wherein the switch is a dimmer switch associated with an interior rear view mirror of the vehicle.

16. The method according to claim 10 wherein detecting a command for switching includes detecting a signal from an optical sensor associated with an auto dimmer of an interior rear view mirror of the vehicle.

17. A mirror positioning system for a vehicle, said system comprising:
a driver side mirror;
a passenger side mirror;
an interior rear view mirror;
a switch for switching between a blind zone mirror position and a blind zone/glare elimination mirror position; and
a controller responsive to a mirror switching signal from the switch, said controller determining a current angle of the driver side mirror, determining whether the driver side mirror is in the blind zone mirror position or the blind zone/glare elimination mirror position based on the angle, and moving the driver side mirror to the other of the blind zone mirror position or the blind zone/glare elimination mirror position in response to the signal.

18. The system according to claim 17 wherein the controller determines the position of a vehicle operators eyes based on the angle of the driver side mirror.

19. The system according to claim 17 wherein the controller automatically sets the angle of the passenger side mirror based on the angle of the driver side mirror.

20. The system according to claim 17 wherein the controller automatically sets the angle of the interior rear view mirror of the vehicle based on the angle of the driver side mirror.

21. The system according to claim 17 wherein the switch is a stand-alone switch.

22. The system according to claim 17 wherein the switch is a dimmer switch associated with an interior rear view mirror of the vehicle.

23. The system according to claim 17 wherein the switch is an optical sensor associated with an auto dimmer of an interior rear view mirror of the vehicle.
